(19) United States
(12) Patent Application Publication
(10) Pub. No.: US 2012/0265808 A1
(43) Pub. Date: Oct. 18, 2012

(54) CONTEXTUAL COLLABORATION

(75) Inventors: Joel M. Ezell, Broomfield, CO (US); Jeffrey G. Gartner, Hopewell Junction, NY (US)

(73) Assignee: AVAYA INC., Basking Ridge, NJ (US)

(21) Appl. No.: 13/087,657

(22) Filed: Apr. 15, 2011

(51) Int. Cl. G06F 15/16

(52) U.S. Cl. 709/204

(57) ABSTRACT

An activity stream is created in a first medium. The activity stream is a mechanism where participants can collaborate on a subject. Participants are added to the activity stream. A participant in the activity stream initiates a communication in a second medium. The status of the communication is determined. If the status of the communication is active, the status of the communication is indicated in the activity stream.

The status can be information that is parsed from the communication, an invitation to join the communication, a link to a recording of the communication, a link to the communication, a conversion of a voice communication to text, an indication to create a second communication in a second medium, and the like. How participants interact can be controlled by default parameters or based on a profile.

### TECHNICAL FIELD

The system and method relates to communication systems and in particular to collaborative communication systems.

### BACKGROUND

Communication systems today tend to be disparate, and lack the ability to convey information/status to other types of media systems. When people collaborate using communication systems, such as email, blog sites, Instant Messaging (IM), telephony systems, and the like, the communications tend to be confined to the specific medium being used. For example, if a group of people are collaborating via email on a specific subject, as some of the members of the group communicate about the subject in other media, such as the telephone, the information in the telephone communication is not associated with the original collaboration nor is it communicated to, or available to, all the members of the group. Moreover, for compliance/legal purposes, all communications on a particular topic may need to be stored and produced on demand. However, trying to pull this information from all the sources may be time-consuming, and in many instances incomplete.

This can result in poor communication between members of the group because some members may have more information than others. Other problems can occur as well, such as duplication of effort. For example, someone may spend a significant amount of time replying to an email and find out later that the issue has been resolved previously by others in the group via a different medium. What is needed is a way to tie together the activities these disparate media systems facilitate to provide a more effective solution that is available to all members of the activity and others who may be interested.

### SUMMARY

The system and method are directed to solving these and other problems and disadvantages of the prior art. An activity stream is created in a first medium. The activity stream is a mechanism where participants can collaborate on a subject, using one or more modes that get associated and stored. Participants are added to the activity stream. A participant in the activity stream initiates a communication in a second medium. A status of the communication is determined. If the status of the communication is active, the status of the communication is indicated in the activity stream.

The status can be presented in various ways. For example, the status can be information that is parsed from the communication, an invitation to join the communication, a link to a recording of the communication, a link to the communication, a conversion of a voice communication to text, an indication to create a second communication in a second medium, and the like. How participants interact can be controlled by default parameters and/or based on a profile.

The system and method also provide the ability for participants in the communication to control access in terms of how others can join the communication based on the profile. The activity stream and the communication can use different types of communication, such as voice, video, Instant Messaging (IM), email, blog sites, social networks, and the like.

### BRIEF DESCRIPTION OF THE DRAWINGS

In order to describe the manner in which other advantages and features of the disclosure can be obtained, a more particular description of the principles and the best mode briefly described below will be rendered by reference to specific embodiments thereof, which are illustrated in the appended drawings. Understand that these drawings depict only exemplary embodiments of the disclosure and are not therefore to be considered to be limiting of its scope; the principles herein are described and explained with additional specificity and detail through the use of the accompanying drawings in which:

FIG. 1 is a block diagram of a first illustrative system for providing a status of a communication into an activity stream.

FIG. 2 is a block diagram of a second illustrative system for providing a status of a communication into an activity stream.

FIG. 3 is a block diagram of a third illustrative system for providing a status of a communication into an activity stream.

FIG. 4 is a flow diagram of a method for providing a status of a communication into an activity stream.

FIG. 5 is a flow diagram of a method of various ways to indicate a status of a communication into an activity stream.

FIG. 6 is a flow diagram of a method for allowing a participant to join a communication.

FIG. 7 is a diagram of an exemplary way of allowing a participant to join a communication with a Graphical User Interface (GUI).

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

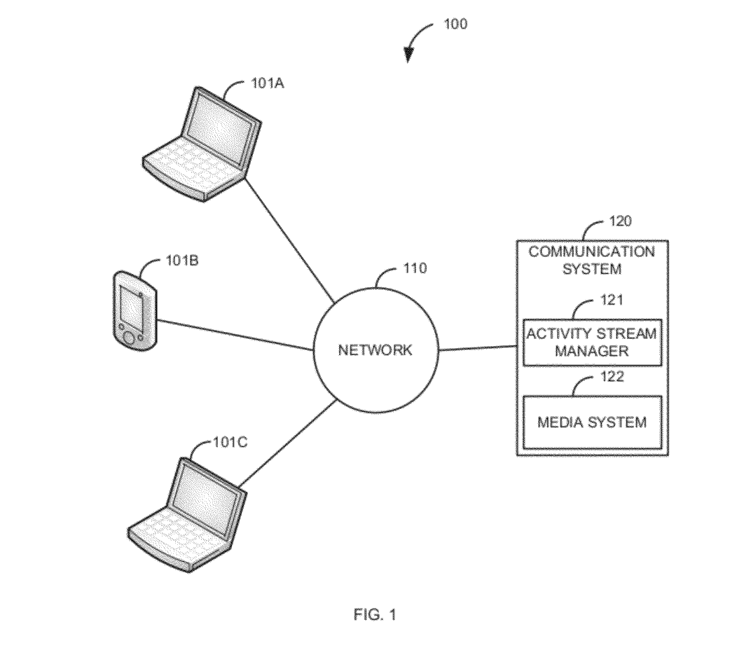

FIG. 1 is a block diagram of a first illustrative system 100 for providing a status of a communication into an activity stream. The first illustrative system 100 comprises communication devices 101A-101C, network 110, and communication system 120. Communication devices 101A-101C can be any type of communication device, such as a Personal Computer (PC), a laptop computer, a Personal Digital Assistant (PDA), a telephone, a tablet computer, and the like.

Network 110 can be any type of network, such as a Local Area Network (LAN), a Wide Area Network (WAN), the Internet, the Public Switched Telephone Network (PSTN), a cellular network, a wireless network, a wired network, a packet switched network, a circuit switched network, a combination of these, and the like. Network 110 connects communication devices 101A-101C to communication system 120.

Communication system 120 can be any type of communication system that can communicate with communication devices 101A-101C, such as a server, a Private Branch Exchange (PBX), an email server, a web server, a video server, a combination of these, and the like. Communication system 120 further comprises activity stream manager 121 and media system 122.

Activity stream manager 121 can be any hardware/software that can manage communications between different participants in an activity stream. The activity stream is a communication that allows participants to collaborate on one or more subjects. For example, an email chain can be considered an activity stream. After the initial email, participants in the email chain continue to discuss the subject by responding to the email. An activity stream is not limited to email activities. For instance, an activity stream can be comprised of any combination of a voice call or conference, a video call or conference, a blog site, a social network, an Instant Message, and the like.

Media system 122 can be any hardware/software that can communicate in a medium. Media system 122 can comprise one or more disparate systems, such as a Private Branch Exchange (PBX), an Instant Message system, a video system, an email system, and the like. For example, activity stream manager 121 can be a social network such as FaceBook™ and media system 122 can be a Private Branch Exchange.

Activity stream manager 121 creates an activity stream in a first medium. A medium is a channel of communication. Different mediums can still use the same base type of communication (i.e., text communication). For example, one medium may be email and a second medium may be Instant Message or a blog site. Likewise, different mediums can use different types of communication. For instance, one medium may be a video conference and another may be a voice medium. An activity stream is a communication between participants that is stored so that the activity stream can be viewed, heard, and/or seen by participants. For example, the activity stream can be a voice activity stream that is recorded or converted to text.

Activity stream manager 121 adds two or more participants (a plurality) to the activity stream. Participants can be added to the media stream at different times, either automatically or manually. The plurality of participants can all be added when the media stream is created or participants in the media stream can be added at different times after the media stream is created. For example, a media stream can be an email. When a person creates an initial email, the activity stream can be optionally created and the creator of the email is added as a participant in the activity stream. As users respond to the email, they can be added as participants in the activity stream. Alternatively, all participants to whom the email is sent can be automatically added to the activity stream. Participants can be added manually. For example, someone can be added to an activity stream based on needing a legal expert on a particular topic. A person may learn about the activity stream and request to be added.

A participant will typically participate in the activity stream from one of the communication devices 101A-101C. For example, participants in a blog site (activity stream) collaborate by typing responses from communication devices 101 that connect to a web server.

In other embodiments, an existing email chain can be used to create an activity stream with participants. One way this can be accomplished is by a user creating the activity stream and only identifying select participants to be included as participants in the activity stream. Optionally, a user can create an activity stream and include all participants in the activity stream.

Based on the activity stream, a participant in the activity stream initiates a communication in a second media. Creating a communication in a second media from the activity stream can be accomplished in various ways. For example, a participant on a blog site (activity stream) could get a list of media types to initiate the communication (e.g., initiate a voice or video communication with a specific participant in the activity stream) by right clicking a mouse over the text of the blog, clicking a button on the blog site, and the like.

Media system 122 determines the status of the communication (i.e., whether the communication is still active). In response to the status being active, activity stream manager 121 indicates the status of the communication in the activity stream. For example, if a voice call was made from a social network activity stream, the status of the voice communication could be a line of text in the social network that indicates that a voice call is active between participant X and participant Y.

To further illustrate how the above system can work, consider the following example. Joel and Jeff (from communication devices 101A and 101B) create an activity stream to discuss topic X. As part of the creation of the activity stream, Joel and Jeff are added as participants in the activity stream. Joel and Jeff communicate back and forth on topic X. From the activity stream, Joel decides to initiate a communication on his FaceBook™ account to discuss topic X with some of his friends. The status of the FaceBook™ communication is conveyed back into the activity stream to indicate that Joel is communicating on topic X (or has posted about topic X) on his FaceBook™ account. Jeff sees in the activity stream that Joel is discussing/posted on the topic on his FaceBook™ account. The status of the communication also includes a link so that Jeff can join the communication on FaceBook™. Jeff clicks the link and automatically joins the communication on FaceBook™.

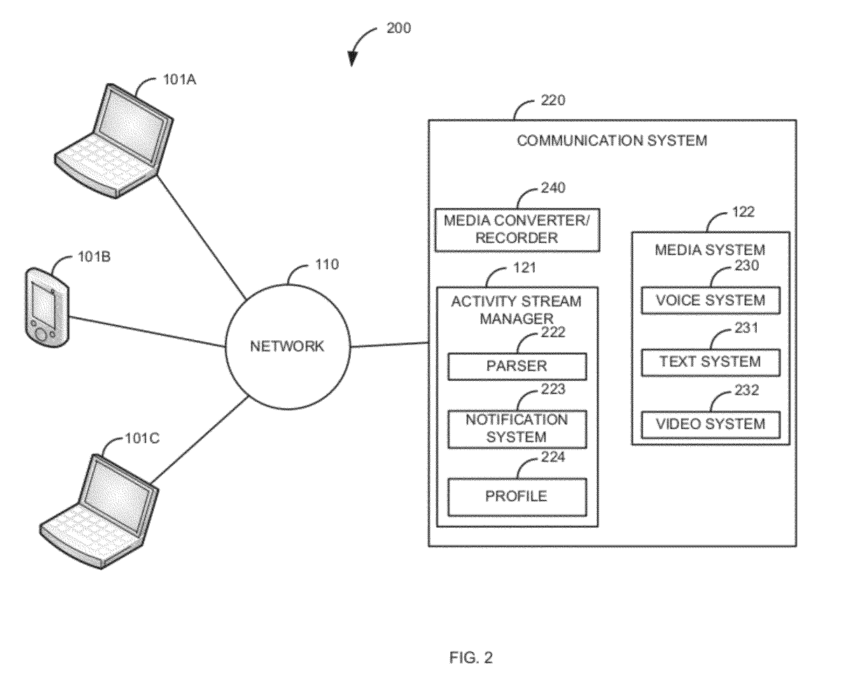

FIG. 2 is a block diagram of a second illustrative system 200 for providing a status of a communication into an activity stream. The second illustrative system 200 comprises communication devices 101A-101C, Network 110, and communication system 220.

Communication system 220 further comprises activity stream manager 121, media system 122, and media converter/recorder 240. Media converter/recorder 240 can be any hardware/software that can convert data in one media to another media and/or record data in one or more media. For example, media converter/recorder 240 can convert voice from a video conference or audio conference to text or convert text from a text media to voice. Media converter/recorder 240 can record text, voice, and/or video.

Activity stream manager 121 further comprises parser 222, notification system 223, and profile 224. Parser 222 can be any hardware/software that can parse media to identify words, phrases, symbols, pictures, objects, and the like. For example, parser 222 can be used to identify a symbol in a video stream or to identify a phrase in an audio stream.

Notification system 223 can be any hardware/software that can send a notification to a participant in the activity stream. For example, notification system 223 can be an email system (text system 231), an Instant Message (IM) system (text system 231), video system 232, voice system 230, a speaker, a web page, an alarm system, a desktop software that pops-up an alert, and the like.

Profile 224 can be any type of configuration information that is stored in memory. For example, profile 224 can contain configuration information or rules about under what circumstance to notify a participant, key words to look for in an audio stream, key words to look for in a text stream, algorithms to use to identify key words, key symbols to look for in a video stream, specific participants of the activity stream to notify (i.e., based on the specific participant's preferences), what media to use to notify a participant, specific times to notify a participant, specific times not to notify a participant, whether to automatically add a participant to a communication, what participants in the activity stream can see the status, and the like.

Media system 122 further comprises voice system 230, text system 231, and video system 232. Voice system 230 can be any voice system, such as a Private Branch Exchange (PBX), a cellular system, a voice mail system, a public telephone system, and the like. Text system 231 can be any system that allows users to communicate via text, such as a blog site, a social network, an email system, an Instant Message (IM) system, and the like. Video system 232 can be any system that allows users to communicate via voice, such as a video server, a video conference system, and the like.

Activity stream manager 121 creates an activity stream in a first medium. A medium is a channel of communication. Activity stream manager 121 adds two or more participants (a plurality) to the activity stream in a first media. A participant in the activity stream initiates a communication based on the activity stream in a second media. For example, the communication can be initiated using voice system 230, text system 231, and/or video system 232. The initiation of the communication and the type of communication can be based on a selection or action (e.g., voice command) by the participant, based on configuration information in profile 224, and/or the like.

Media system 122 determines the status of the communication (i.e., whether the communication is still active). In response to the status being active, activity stream manager 121 indicates the status of the communication in the activity stream. The status of the communication can be presented in various ways. For example, parser 222 can parse the communication for key words/phrases and convey the key words/phrases in the activity stream. In alternative embodiments, media converter/recorder 240 can convert a voice communication into text and indicate the status of the voice communication by presenting the converted voice communication text in the activity stream.

Notification system 223 can also be used to notify a participant in the activity stream. For example, when a participant of the activity stream initiates a communication in the second medium, notification system 223 can send an email, an Instant Message (IM), a voice mail, and the like to notify a participant who is not in the communication to join the communication.

To further illustrate the system of FIG. 2, consider the following example. Doug sends an e-mail to Joel, Jeff, and Sally. An activity stream is automatically created with Doug, Joel, Jeff, and Sally as participants. Jeff starts to type a response to Doug. Sally starts to type a response, but sees directly from her e-mail client (which is tied into activity stream manager 121) that Jeff is already typing a response to Doug. Sally launches an instant message communication to Jeff asking if he'd like to collaborate on a response.

Jeff responds that he'd like to do so and a voice/desktop sharing communication is created. Joel sees from his e-mail client that Jeff and Sally are collaborating in the context of this activity stream (e-mail thread). The e-mail client has a button that allows him to ask to be included in the collaboration session and Joel invokes this action. Jeff and Sally both see this request. Jeff is initially inclined to tell Joel to get lost but then grudgingly allows him to join the session. Joel is seamlessly joined into the voice and screen sharing collaboration session. Jeff, Joel, and Sally complete their combined response and Sally sends it off to Doug.

It should be noted that anybody not part of the activity stream would be able to see through well-known mechanisms that both Jeff and Sally were in a call, but only Joel and Doug could see that they were talking to each other, and about this topic.

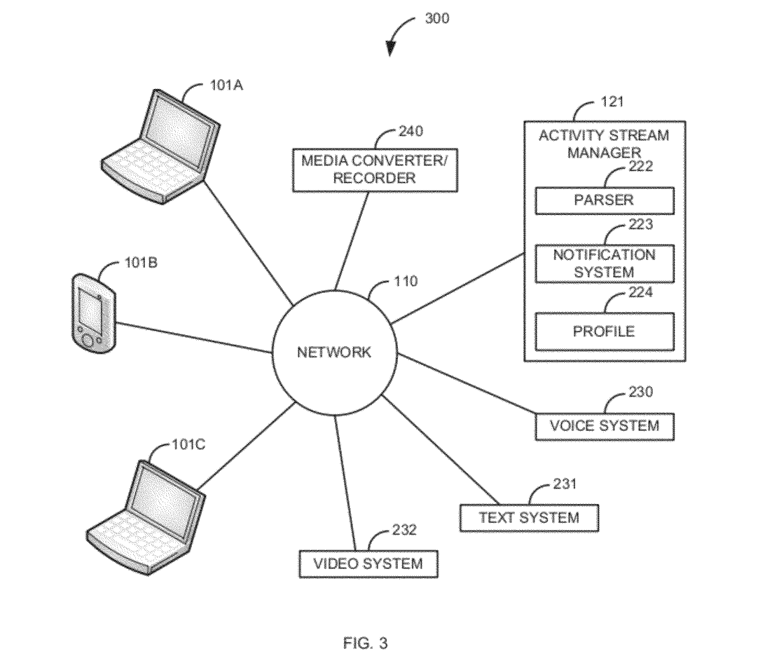

FIG. 3 is a block diagram of a third illustrative system 300 for providing a status of a communication into an activity stream. FIG. 3 is an illustrative example of a distributed system of FIG. 2. The third illustrative system 300 comprises communication devices 101A-101C, network 110, media converter/recorder 240, activity stream manager 121, voice system 230, text system 231, and video system 232. In this example, communication devices 101A-101C, media converter 240, activity stream manager 121, voice system 230, text system 231, and video system 232 are shown being connected via network 110.

Activity stream manager 121 is shown comprising parser 222, notification system 223, and profile 224. However, parser 222, notification system 223, and profile 224 can be distributed and separate from activity stream manager 121.

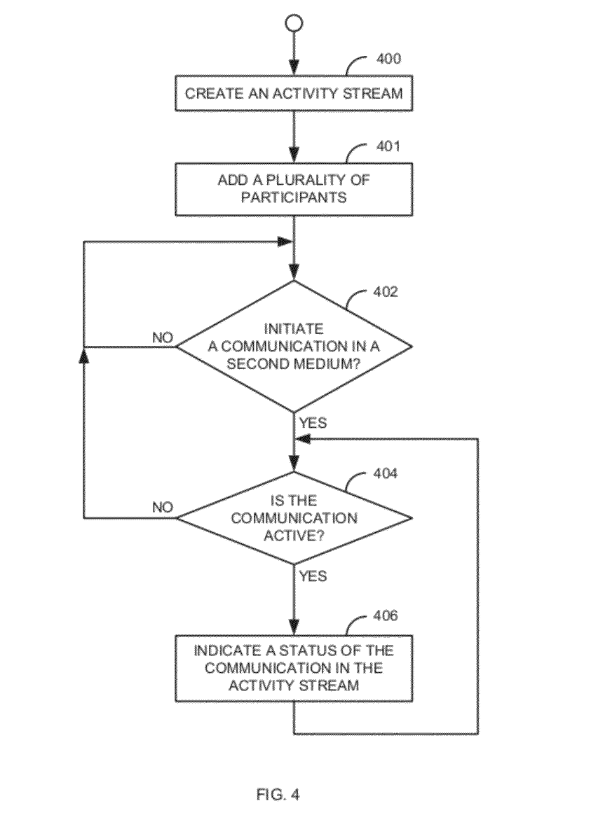

FIG. 4 is a flow diagram of a method for providing a status of a communication into an activity stream. Illustratively, communication devices 101A-101C, media converter/recorder 240, activity stream manager 121, communication systems 120/220, parser 222, notification system 223, media system 122, voice system 230, text system 231, and video system 232 are stored-program-controlled entities, such as a computer or processor, which performs the method of FIGS. 4-7 and the processes described herein by executing program instructions stored in a tangible computer readable storage medium, such as a memory or disk.

Activity stream manager 121 creates 400 an activity stream in a first medium. Activity stream manager 121 adds 401 two or more participants (a plurality) to the activity stream in a first media. A participant will typically participate in the activity stream from one of communication devices 101A-101C.

The process waits in step 402 for a participant in the activity stream to initiate a communication in a second medium. If a participant in the activity stream does not initiate a communication in a second medium, the process repeats step 402. Otherwise, if a participant in the activity stream initiates a communication in a second media that is not part of the activity stream in step 402, media system 122 determines in step 404 if the communication is active.

Media system 122 can determine if the communication is active in various ways. For example, for voice and video communications, a communication can be active if there are still 2 or more participants in the communication. For text communications such as email, a communication may be active for an indefinite period of time and/or may be considered active only when someone is actively typing a response. This could be accomplished using different indicators, such as an active typing indicator and a recent email indicator. For email, a communication may be deemed inactive after a specific time period after the last response to the email, after all the emails in an email chain have been deleted or archived, and the like. For a blog site/social network, a communication may be active as long as the communication is still posted. How a communication is considered active can be defined in profile 224.

If the communication is not active in step 404, the process goes to step 402. Otherwise, if the communication is active in step 404, activity stream manager 121 indicates 406 a status of the communication in the activity stream.

The above process can be implemented in various ways using various media. For example, in one embodiment, the first medium can be a text medium, the second medium can be a voice medium, and the status can be a real-time conversion of the voice communication to text.

In another embodiment, the first medium can be a text medium, the second medium can be a video medium, and the status can include one or more of the following: a link to a recording of the video communication, a link to a recording of an audio portion of the video communication, a real-time conversion of the audio portion of the video communication to text, an indication to join the video communication, an indication to initiate a second communication in a non-video medium, and the like.

In yet another embodiment, the first medium can be a video medium, the second medium can be a text medium, and the status of the communication can be a text message displayed in the video activity stream, a text message displayed in conjunction with the video activity stream, and the like.

In another embodiment, the first medium can be a voice medium, the second medium can be a text medium, and the status of the communication can be an audio indication in the voice activity stream that the text communication has been initiated.

Moreover, the first medium can be a text medium, the second medium can be a text medium, and the status of the communication can be one or more of the following: an indication to initiate a second communication in an audio medium, an indication to initiate the second communication in a video medium, an indication to join the communication, and the like.

The above descriptions are not intended to be exhaustive of various ways the system and method can be implemented. Like the various combinations of media discussed above, one skilled in the art would recognize that there are other combinations of media and status that would be obvious based on the above descriptions.

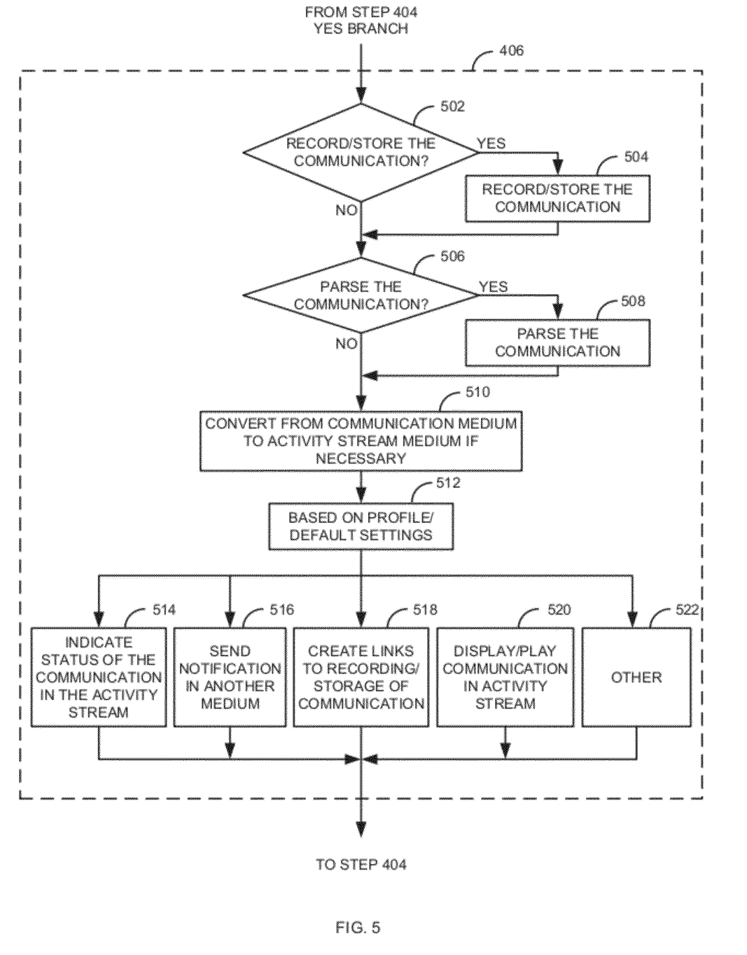

FIG. 5 is a flow diagram of a method of various ways to indicate a status of a communication into an activity stream. FIG. 5 is an illustrative view of different ways that step 406 of FIG. 4 can be implemented. After determining that the communication is active in step 404, media converter/recorder 240 determines in step 502 if recording/storing of the communication is required. This can be based on rules in profile 224. If media converter/recorder 240 determines in step 502 to record/store the communication, media converter/recorder 240 records/stores 504 the communication and the process goes to step 506.

If media converter/recorder 240 determines in step 504 to not record/store the communication, parser 222 determines in step 506 whether to parse the communication. Parser 222 can parse the communication in different ways. For example, parser 222 can parse the communication based on word occurrence, word ranking, a topic field in a text message, information that a participant enters when initiating the communication, and the like. How the communication is parsed can be defined in profile 224. If parser 222 determines in step 506 to parse the communication, parser 222 parses 508 the communication and the process goes to step 510.

If parser 222 determines in step 506 not to parse the communication, media converter/recorder 240 converts 510 the communication media to the activity stream media if necessary. Conversion from one media to another in step 510 is based on the media type of the activity stream, the media type of the communication, and how the status is conveyed to the participant in the activity stream. For example, if the activity stream is a text media, the communication media is a voice communication, and the status is parsed key words from the voice communication, the parsed key words from the voice communication will be converted from voice to text and placed in the text activity stream. Based on profile 224/default settings, different events 514, 516, 518, 520, and/or 522 can occur.

In step 514, the status of the communication is indicated in the activity stream. This can be done in various ways, such as creating a button to join the communication, creating a link to the communication, displaying parsed text from the communication, displaying the communication, displaying that the communication is active, displaying a telephone number that a participant can call to join a conference call, and the like.

In step 516, a notification can be sent by notification system 223 based on the communication. This may be accomplished in a different medium from the activity stream and/or the communication. For example, if the activity stream is a social network and the communication is a voice conference, based on the initiation of the voice conference communication the notification can be sent using email or Instant Messaging (IM). The notice can be sent based on a presence indication of which media may be best to contact the participant. The notice can also contain an indication (e.g., a button or link) that provides the participant an option to join the communication automatically.

In step 518, activity stream manager 121 can create links to recordings of the stored communication. For example, if the communication was a voice communication, a link can be provided that points to a recording of the communication. Similarly, if the communication was a post on a social network, the link can be to the social network where the participant can view the post.

In step 520, activity stream manager 121 can display/play (depending on the media type) the communication in the activity stream. For example, if the first media type was a voice media, the communication can be played to a user based on a key press. Likewise, step 522 allows for other ways to indicate the status. Once completing the necessary steps (514, 516, 518, 520, and/or 522), the process goes to step 404.

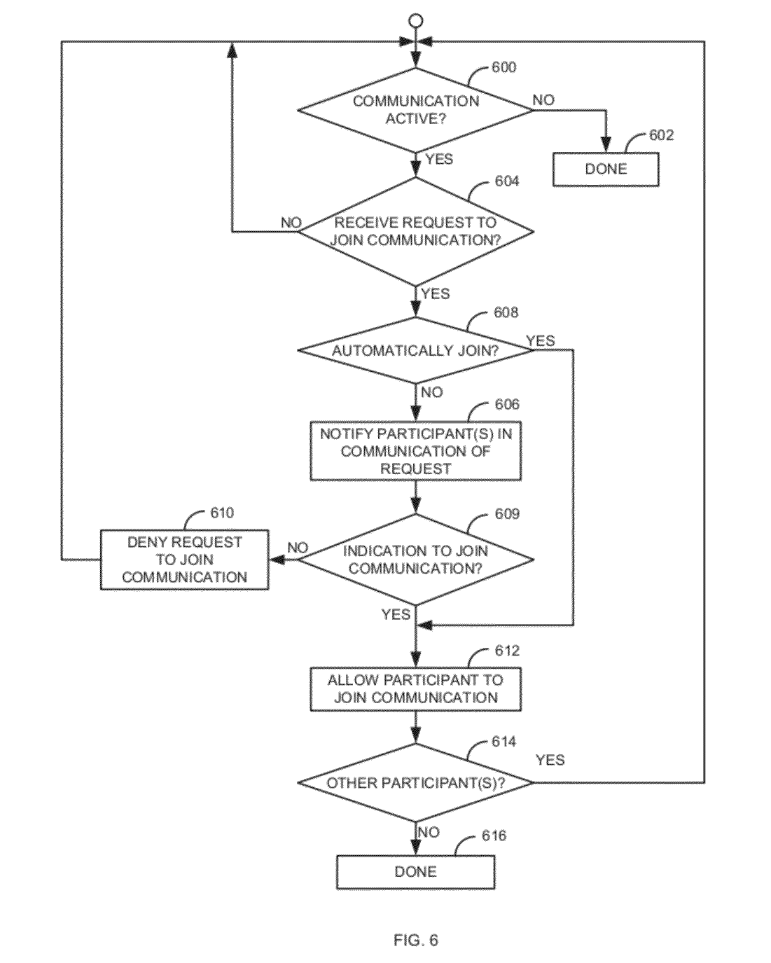

FIG. 6 is a flow diagram of a method for allowing a participant to join a communication. The process begins in step 600. Media system 122 determines in step 600 if the communication is active. If the communication is not active in step 600, the process is done 602. Otherwise, if the communication is active in step 600, activity stream manager 121 determines if there has been a request to join the communication in step 604. A request to join the communication can be received based on a participant of the activity stream clicking on a link, clicking on a button, and the like (i.e., generated in step 514 and/or 516). If there is not a request to join the communication in step 604, the process goes back to step 600.

Otherwise, if there is a request to join the communication in step 604, media system 122 determines in step 608 if the participant in the activity stream is allowed to automatically join the communication. If the participant is allowed to automatically join the communication (i.e., based on profile 224) in step 608, the process goes to step 612.

Otherwise, if the participant is not allowed to automatically join the communication (i.e., based on profile 224) in step 608, one or more of the participants in the communication are notified 606 of the request to join the communication. Which participants see the request can also be based on profile 224. If the participant(s) in the communication indicate that the participant who is not in the communication cannot join the communication in step 609, activity stream manager 121 denies 610 the request to join the communication. Joining the communication can require the approval of one participant in the communication, a subset of all participants in the communication, or all of the participants in the communication based on profile 224. If the indication to join the communication is received in step 609, media system 122 allows 612 the participant who is not part of the communication to join the communication.

In step 614 activity stream manager 121 determines if there are other participants in the activity stream who may want to join the communication. If there are not any other participants in the activity stream who may want to join the communication in step 614, the process is done 616. Otherwise, if there are other participants who may want to join the communication in step 614, the process goes to step 600.

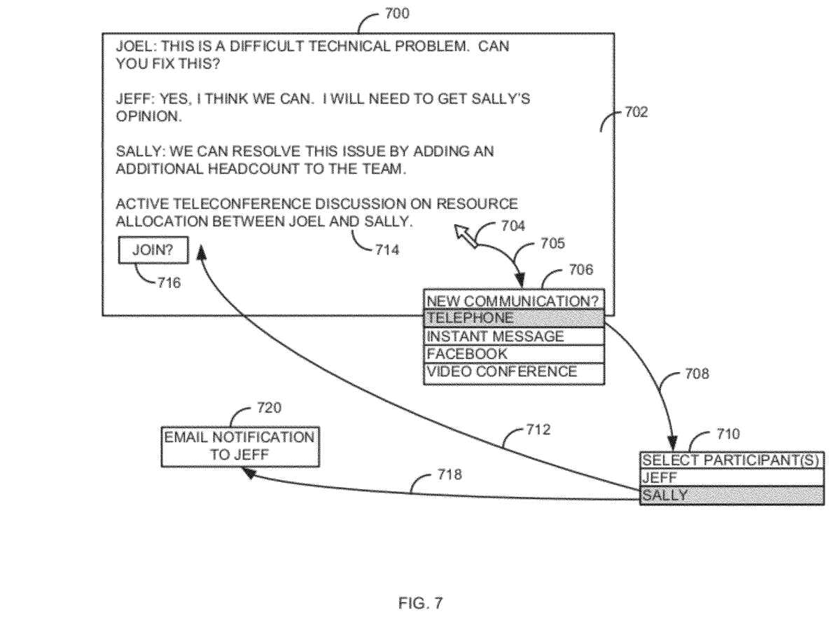

FIG. 7 is a diagram of an exemplary way of allowing a participant to join a communication with a Graphical User Interface (GUI) 700. In this illustrative example, GUI 700 represents a text-based activity stream 702. Activity stream 702 shows a communication between three participants: Joel, Jeff, and Sally. Activity stream 702 is shown from the perspective of participant Joel.

As Joel is viewing activity stream 702, Joel decides he wants to initiate a telephone communication with Sally. Joel places cursor 704 on activity stream 702 and right clicks 705 a mouse (not shown). This results in the display of communication window 706 to Joel. Joel selects 708 the telephone media option in communication window 706. This results in the display of participant window 710. Joel selects Sally as the only participant he wants to talk to. The indication that Joel wants to communicate with Sally results a voice communication that is initiated between Joel and Sally. Based on the initiation of the voice communication, the status 714 (text) and 716 (button) of the voice communication are indicated 712 in activity stream 702.

In this example, the status is information 714 that is parsed by parser 222 from the voice communication and a button 716 to join the communication. Jeff can now see the status in his view of the activity stream and can request to join the voice communication between Joel and Sally. Jeff can also receive 718 a notification 720 via a different media, such as email, indicating the voice communication has been initiated.

Herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Herein, the terms “a,” “an,” or another entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
creating an activity stream in a first medium;
adding a plurality of participants to the activity stream;
initiating a communication in a second medium by a participant of the activity stream based on the activity stream;
determining a status of the communication; and
in response to the status being active, indicating the status of the communication in the activity stream.

2. The method of claim 1, wherein the status of the communication contains information that is parsed from the communication.

3. The method of claim 1, wherein the status of the communication further comprises: creating an indication in the activity stream to a participant of the plurality of participants who is not in the communication, wherein the indication presents an option to join the communication.

4. The method of claim 3, further comprising the steps of:
receiving a request from the participant of the plurality of participants who is not in the communication requesting to join the communication;
in response to the request to join the communication, doing one of the following:
a. automatically joining the participant of the plurality of participants who is not in the communication into the communication; or
b. notifying a participant in the communication of the request to join the communication;
in response to the notifying step, receiving:
i. an indication to join the communication; or
ii. an indication not to join the communication; and
in response to receiving the indication to join the communication, joining the participant of the plurality of participants who was not in the communication into the communication.

5. The method of claim 4, wherein the participant in the communication is a plurality of participants in the communication and the indication to join the communication is approved by the plurality of participants in the communication.

6. The method of claim 1, further comprising a profile, wherein the profile defines rules on which the plurality of participants in the activity stream are allowed to see the status.

7. The method of claim 1, further comprising the step of sending a notice to a participant in the activity stream who is not part of the communication, wherein the notice is based on the initiation of the communication, the notice is sent in a medium that is not part of the activity stream, and the notice contains an indication that allows the participant in the activity stream who is not part of the communication to automatically join the communication.

8. The method of claim 1, wherein the first medium is a text medium, the second medium is a voice medium, and the status of the communication comprises a real-time conversion of the communication to text.

9. The method of claim 1, wherein the first medium is a text medium, the second medium is a video medium, and the status of the communication comprises at least one of the following: a link to a recording of the communication, a link to a recording of an audio portion of the communication, a real-time conversion of the audio portion of the communication to text, an indication to join the communication, and an indication to initiate a second communication in a non-video medium.

10. The method of claim 1, wherein the first medium is a video medium, the second medium is a text medium, and the status of the communication comprises a text message displayed in the first medium or displayed in conjunction with the first medium.

11. The method of claim 1, wherein the first medium is a voice medium, the second medium is a text medium, and the status of the communication comprises an audio indication that the communication has been initiated.

12. The method of claim 1, wherein the first medium is a text medium, the second medium is a text medium, and the status of the communication comprises at least one of the following: an indication to initiate a second communication in an audio medium, an indication to initiate the second communication in a video medium, and an indication to join the communication.

13. The method of claim 1, wherein the activity stream is created based on a prior communication.

14. A system comprising:
an activity stream manager operable to create an activity stream in a first medium, add a plurality of participants to the activity stream, and indicate in the activity stream, a status of a communication in a second medium, wherein the status of the communication is indicated in response to the status of the communication being active; and
a media system operable to determine the status of the communication and initiate the communication in the second medium, wherein the communication is initiated by a participant of the activity stream based on the activity stream.

15. The system of claim 14, wherein the status of the communication contains information that is parsed by a parser, wherein the information is parsed from the communication.

16. The system of claim 14, wherein the activity stream manager is further operable to indicate the status of the communication by creating an indication in the activity stream to a participant of the plurality of participants who is not in the communication, wherein the indication presents an option to join the communication.

17. The system of claim 16, wherein:
the activity stream manager is further operable to receive a request from the participant of the plurality of participants who is not in the communication requesting to join the communication and in response to the request to join the communication, the media system is operable to do one of the following:
c. automatically join the participant of the plurality of participants who is not in the communication into the communication; or
d. notify a participant in the communication of the request to join the communication;
in response to notifying the participant, receiving:
i. an indication to join the communication; or
ii. an indication not to join the communication; and
in response to receiving the indication to join the communication, joining the participant of the plurality of participants who was not in the communication into the communication.

18. The system of claim 17, wherein the participant in the communication is a plurality of participants in the communication and the indication to join the communication is approved by the plurality of participants in the communication.

19. The system of claim 14, further comprising a profile, wherein the profile defines rules on which the plurality of participants in the activity stream are allowed to see the status.

20. The system of claim 14, further comprising a notification system operable to send a notice to a participant in the activity stream who is not part of the communication, wherein the notice is based on the initiation of the communication, the notice is sent in a medium that is not part of the activity stream, and the notice contains an indication that allows the participant in the activity stream who is not part of the communication to automatically join the communication.

21. The system of claim 14, wherein the first medium is a text medium, the second medium is a voice medium, and the status of the communication comprises a real-time conversion of the communication to text.

22. The system of claim 14, wherein the first medium is a text medium, the second medium is a video medium, and the status of the communication comprises at least one of the following: a link to a recording of the communication, a link to a recording of an audio portion of the communication, a real-time conversion of the audio portion of the communication to text, an indication to join the communication, and an indication to initiate a second communication in a non-video medium.

23. The system of claim 14, wherein the first medium is a video medium, the second medium is a text medium, and the status of the communication comprises a text message displayed in the first medium or displayed in conjunction with the first medium.

24. The system of claim 14, wherein the first medium is a voice medium, the second medium is a text medium, and the status of the communication comprises an audio indication that the communication has been initiated.

25. The system of claim 14, wherein the first medium is a text medium, the second medium is a text medium, and the status of the communication comprises at least one of the following: an indication to initiate a second communication in an audio medium, an indication to initiate the second communication in a video medium, and an indication to join the communication.

26. The method of claim 14, wherein the activity stream is created based on a prior communication.
